(19) United States
(12) Patent Application Publication
(10) Pub. No.: US 2009/0246101 A1
(43) Pub. Date: Oct. 1, 2009

(54) Apparatus for Rapid Oxidation using UV Radiation

(76) Inventors: Rocco D. Pochy, Fremont, CA (US); Scott S. Salton, Fremont, CA (US); Thomas C. Saunders, Fremont, CA (US)

Correspondence Address: GREENBERG & LIEBERMAN, LLC, 2141 WISCONSIN AVE, N.W., SUITE C-2, WASHINGTON, DC, 20007, US

(21) Appl. No.: 12/416,776

(22) Filed: Apr. 1, 2009

Related U.S. Application Data
(60) Provisional application No. 61/041,504, filed on Apr. 1, 2008.

(51) Int. Cl. B01J 19/08

(52) U.S. Cl. 422/186.3

(57) ABSTRACT

An apparatus employing a UV reaction chamber that produces light for levying high-level amounts of hydroxyl radicals during the oxidation process. The flow passes through a fluid intake and into the UV reaction chamber. A metallic coating on the outer shell and quartz reactor work for increased efficiency during the oxidation process, as does a coolant tube. The apparatus is connected to a number of conceivable systems as the apparatus aids in the rapid oxidation process of the water flow.

This is a non-provisional application claiming priority to provisional patent application No. 61/041,504 filed on Apr. 1, 2008.

### FIELD OF THE INVENTION

The present invention is an ultra-violet (UV) apparatus comprising a UV reaction chamber, coolant tube, quartz reactor and gas discharge element that together are used to breakdown organic compounds by exposing the water flow to intense UV radiation.

### BACKGROUND OF THE INVENTION

There are applications that require water samples to be exposed to intense ultraviolet radiation in order to sterilize or breakdown contamination in a fluid stream. An example of this is the measurement of organic components in ultra-pure water.

In this example, the UV radiation breakdowns down the carbon molecules and oxidize them to form an acid. The concentration of the acid changes the conductivity of the liquid. By measuring the difference between the incoming water and the oxidized water, one can compute the amount of carbon that was oxidized. The most common means of generating UV radiation is via a mercury vapor lamp. The limitation with existing technologies it that the UV lamp has a poor efficiency that results in long processing times to get the carbon to oxidizes. By operating at high power modes, the lamp degrades rapidly over time requiring frequent replacement.

The use of common UV sources such as mercury lamps requires extended exposure times to complete the oxidation process. The use of reagents is sometimes used as a catalyst to speed up this reaction. However, this scenario requires the user to constantly monitor and maintain a supply of reagents to assure operation of the apparatus. It also should be noted that various total organic carbon (TOC) values that are not immediately detected could detrimentally affect the safety and contamination levels of products. Because of these issues relating to the important area of water purity, there is a need for an apparatus that can perform rapid oxidation without the need for catalysts or reagents.

The present invention solves this need in a novel manner. Through the use of a highly efficient UV reaction chamber, the present invention performs the rapid oxidation of carbon compounds without the need for catalysts or reagents. Moreover, the present invention minimizes contamination by limiting contact with surfaces that are prone to contamination. The present invention also solves the TOC problems by detecting TOC values rapidly for improved safety, prevention of damage to products by contamination, and better control of the processes.

### SUMMARY OF THE PRESENT INVENTION

The present invention relates to an apparatus that allows several passes within a UV chamber to promote fast reaction times within fluid passed through the UV chamber. The present invention provides a higher efficiency lamp operating in the wavelengths that are most destructive to organic compounds. This reduces the time required to oxidized the carbon compounds thus allowing more samples to be taken over a given time interval, improving the time resolution as a monitoring instrument.

The present invention is an apparatus that serves to perform rapid oxidation of carbon compounds while at the same time, reduces the prospects for contamination for an overall system employing the apparatus of the present invention. One conceived purpose of these functions is to measure the dissolved organic compounds in water to provide meaningful indicators relating to the purity of the water.

In such circumstances, the apparatus of the present invention would be beneficial and efficient relating to its metallic coating, quartz reactor, coolant tube, discharge gas element and UV reaction chamber. In the preferred embodiment of the present invention, water runs into the UV reaction chamber. When the water runs into the UV reaction chamber, the water is exposed to intense UV radiation where the organic compounds ultimately are broken down. The water may then be pushed via conventional pumping means toward various sensors or measurement elements depending on the ultimate use of the present invention.

In the preferred embodiment, the UV generated by the gas discharge operates in wavelengths of between 160 nm to 190 nm. In this embodiment, high levels of hydroxyl radicals are produced. That aspect is beneficial for organic oxidation and far more amenable due to the fact that additional catalysts are not necessary. Moreover, the thin layer of high-purity fused quartz that is in the preferred embodiment of the present invention relate to high UV transmission while leaving gaps or layers of air that can cause UV radiation to be lost.

### BRIEF DESCRIPTION OF THE DRAWINGS

FIG. 1 shows a cross-section view of the present invention.

### DETAILED DESCRIPTION OF THE PREFERRED EMBODIMENT

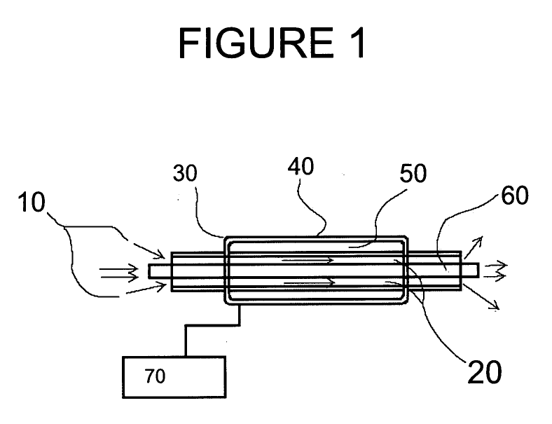

The present invention is an apparatus that can be used in a number of overall systems that require purified water flow. In FIG. 1, we see a view of the present invention. The UV reaction chamber (20) serves to expose the water that has flowed into it to intense UV radiation where the organic compounds of the water is broken down. As we see in FIG. 1, the water enters the UV reaction chamber (20) at the fluid intake (10). In the preferred embodiment of the present invention, the UV reaction chamber (20) is enclosed by a quartz reactor (30). The quartz reactor (30) is a thin layer of high-purity fused quartz that caters to very high UV transmission. The purpose of the quartz reactor (30) is to allow for extremely low loses and simplified construction. The quartz reactor (30) also solidifies the process because it does not leave any gaps, meaning that UV radiation is prevented from being lost due to reflection and absorption.

The UV reaction chamber (20) also is enclosed by a metallic coating (40) in the preferred embodiment. The metal coating is applied to the outer shell of the discharge gas element (50) to act as an electrode. The UV reaction chamber (20) itself in the preferred embodiment produces light at wavelengths of 160 nm to 190 nm. These confines in respect to light lead to high-level production of hydroxyl radicals, which are beneficial to organic oxidation.

Once the water flow passes the UV reaction chamber (20) and the organic compound is broken down, the flow moves on to be monitored, used or whatever purpose the apparatus of the present invention is aiding. The present invention also is capable in alternate embodiments for reversing the flow direction so that the water flow can essentially pass back through the UV reaction chamber (20) if necessary, depending on the use of the overall system that the present invention is connected.

An additional aspect of the present invention, as seen in FIG. 1, relates to a high voltage power supply (70). In this regard, one embodiment or use of the apparatus of the present invention can entail high voltage emitting from the high voltage power supply (70) that is applied to the UV reaction chamber (20). This causes the discharge gas in the discharge gas element (50) to fluoresce with UV radiation. Based on calibrated time values, the UV light remains on to fully oxidize the organic compounds present in the solution. During this time, water is continually running through the coolant tube (60) in order to minimize excessive heating of the water being exposed to the radiation.

We claim:

1. An apparatus for rapid oxidation, comprising:
a UV reaction chamber configured to allow water to flow into it, said UV reaction chamber having a fluid intake as an entry point for said water into said UV reaction chamber;
said UV reaction chamber configured to expose said water to intense UV radiation such that organic compounds in said water are broken down;
a quartz reactor enclosed around said UV reaction chamber;
said quartz reactor being a thin layer of high-purity fused quartz;
said quartz reactor configured without gaps; and
said UV reaction chamber enclosed by a metallic coating at an outer shell of a discharge gas element, said discharge gas element placed with said UV reaction chamber.

2. The apparatus of claim 1, wherein a high voltage power supply is configured to be applied to said UV reaction chamber.

3. The apparatus of claim 2, wherein said high voltage power supply is configured to be applied to said UV reaction chamber such that discharge gas located in said discharge gas element fluoresces with UV radiation.

4. The apparatus of claim 1, wherein said high voltage power supply is configured to be applied to said UV reaction chamber such that discharge gas located in said discharge gas element fluoresces with UV radiation.

5. The apparatus of claim 1, wherein a coolant tube is configured to allow said water to run continually through.
